(19) United States
(12) Patent Application Publication
(10) Pub. No.: US 2023/0064762 A1
(43) Pub. Date: Mar. 2, 2023

(54) LOAD RECEIVING MEANS

(71) Applicant: ROGAMA B.V., Valkenburg (NL)

(72) Inventors: Rob MATTI, Valkenburg (NL); Marcel JAKOBS, Stolberg (DE); Mario LINDENAU, Mönchengladbach (DE)

(21) Appl. No.: 17/780,255

(22) PCT Filed: Nov. 26, 2020
(86) PCT No.: PCT/EP2020/083467

§ 371 Date: Nov. 16, 2022

(30) Foreign Application Priority Data
Nov. 27, 2019 (DE) 10 2019 132 069.0
Nov. 28, 2019 (DE) 10 2019 132 375.4

(51) Int. Cl. B66F 9/075; B66F 9/12

(52) U.S. Cl. CPC B66F 9/0755; B66F 9/12

(57) ABSTRACT

The invention relates to a load pick-up means of an industrial truck or the like having an integrated camera for detecting the environment of the industrial truck. Furthermore, the invention relates to a system that enables the operator of the industrial truck to safely maneuver the industrial truck even when the direct view of the path of travel is limited by a load picked up by the load pick-up means of the industrial truck, and that enables the operator of the industrial truck to determine the exact position of the load in relation to the position of the load pick-up means better than before, in particular when setting down or picking up a load. A first load pick-up means according to the invention has a first portion oriented substantially horizontally in operation and having an extension in the horizontal longitudinal direction x, an extension in the vertical thickness direction y, and an extension in the width direction z, and a second portion arranged substantially perpendicularly to the first portion. Further, the first load pick-up means has integrated image recording optics. The width direction z of the first portion of the first load pick-up means tapers over a ramp in a direction opposite to the second portion of the first load pick-up means, wherein the image recording optics is integrated in the ramp such that an image can be captured in a direction opposite to the second portion of the first load pick-up means.

The invention relates to a load pick-up means of an industrial truck or the like having an integrated camera for detecting the surroundings of the industrial truck. Furthermore, the invention relates to a system which enables the operator of the industrial truck to maneuver the industrial truck safely even in the case of a direct view of the travel path limited by a load picked up by the load pick-up means of the industrial truck, and which enables the operator of the industrial truck to determine the exact position of the load in relation to the position of the load pick-up means better than before, in particular when setting down or picking up a load.

Industrial trucks of this type are operated, for example, as forklifts by a driver who usually picks up loads by sight and experience on the load handling attachment, moves them and sets them down again at another location, possibly also in high-bay warehouses. Such load handling devices belong to the state of the art as forks, which are usually attached in pairs to a fork carriage of an industrial truck.

Due to the load picked up by the load pick-up means, the view in the direction of travel may be restricted for the operator, i.e. driver, of the industrial truck. To solve this problem, it is known to install a camera in the tip of a fork, the image of which is transmitted to a monitor located in the field of view of the operator of the industrial truck.

For the safe and fast storage of pallets in racks at greater heights of a warehouse, a camera is usually mounted on the side of a fork, for example screwed on. It is important to position the camera on the fork in such a way that the driver can easily see on the monitor in the cabin whether the pallet is being moved into the rack and set down correctly. Both the rack layer and the pallet must be visible. Advantageously, standard forks can be used in this embodiment.

However, a camera mounted on the side of a fork also has disadvantages: the camera can be hit and damaged during rough operation of an industrial truck. In addition, the fork tine also becomes wider, making it impossible to pick up some specific pallets and/or requiring the distance between the fork tines to be adjusted more precisely depending on the pallet or load to be picked up. To minimize both of these disadvantages, the lens of the camera must be positioned close to the fork tine, causing the fork tine to protrude far into the camera's pickup area, thus taking up a large portion of the image on the monitor without really providing usable information to the operator.

In the German patent application DE 10 2018 100 370 A1, it is proposed to reduce the disadvantages by partially recessing the camera into a recess in the fork tine. However, by recessing the camera into the fork tine, the usable viewing angle of the camera is further reduced, with the result that even more of the fork tine can be seen in the image projected on the monitor, without this increasing the information content relevant to the driver of the industrial truck. In addition, the camera remains susceptible to impact forces from all sides during startup. In addition, the wedge-shaped design of the camera housing in the front area before the opening for the camera lens results in a sharp edge at the recess, which can lead to injuries. In addition, with this interfering edge there is a risk of getting caught with the edge on the load, load carrier or shelf when the forklift truck is reversed. In addition, the clearance between the camera and the interfering edge can fill with dirt, which can restrict the clear view of the camera lens. To solve these problems, it is suggested that a base be used that has the same exact dimensions as the recess and is mounted to the camera housing so that the camera itself again projects further out from the side plane of the fork tine. This slightly minimizes the camera's susceptibility to damage, but it is still present. In addition, the recess requires the fork tine to be milled out, which is complex and therefore expensive. In addition, visibility remains limited.

The object of the invention is to disclose a load pick-up means which, with a visualization means arranged in the field of view of the operator of an industrial truck, enables the operator of the industrial truck to maneuver the industrial truck safely even with a direct view of the travel path restricted by a load carried on the load pick-up means of the industrial truck. In addition, the angle of view is to be improved compared to the prior art, so that in particular when setting down or picking up a load, the exact position of the load in relation to the position of the load pick-up means can be determined better than before by the driver of the industrial truck, and the device is to be designed to be less susceptible to mechanical damage.

A further task of the invention is to disclose a system which enables the operator of the industrial truck to maneuver the industrial truck safely even in the case of a direct view of the travel path restricted by a load picked up by the load pick-up means of the industrial truck, and which enables the operator of the industrial truck to determine the exact position of the load in relation to the position of the load pick-up means better than before, in particular when setting down or picking up a load.

According to the invention, this task is solved by a load handling device with integrated image recording optics having the features of independent claim 1. Advantageous further developments of the load pick-up means result from dependent claims 2 to 11. The further task of the invention is solved by a system according to claim 12. Advantageous further embodiments of the system result from dependent claims 13 to 17.

An first load pick-up means according to the invention comprises a first portion oriented substantially horizontally in operation and having an extension in the horizontal longitudinal direction x, an extension in the vertical thickness direction y and an extension in the width direction z, and a second portion arranged substantially perpendicularly to the first portion. Further, the first load pick-up means has integrated imaging optics. The width direction z of the first portion of the first load pick-up means tapers over a ramp in the direction opposite to the second portion of the first load pick-up means, wherein the imaging optics are integrated in the ramp in such a way that an image can be taken in the direction opposite to the second portion of the first load pick-up means.

The first load pick-up means has two side surfaces, wherein here and in the following the surfaces arranged in the horizontal longitudinal direction x with a vertical extension in the thickness direction y are referred to as side surfaces. An image recording optical system can be provided either on one or on both side surfaces.

Some terminology will be explained in the following:

First of all, it is explicitly pointed out that, in the context of the present patent application, indefinite articles and numericals such as “one”, “two”, etc. are generally to be understood as indicating a minimum, i.e. as “at least one . . . ”, “at least two . . . ”, etc., unless it becomes clear from the respective context or is obvious or technically imperative for the person skilled in the art that only “exactly one . . . ”, “exactly two . . . ”, etc. can be intended. Furthermore, all numerals as well as indications of process parameters and/or device parameters are to be understood in the technical sense, i.e. as having the usual tolerances. Also, even if explicit restrictions such as “at least” or the like are used, it must not be concluded that if simply “one”, without the indication of “at least” or the like, is indicated, “exactly one” is meant.

The “load pick-up means” is a means for carrying loads, for example a pallet, wherein the load pick-up means may have the form of a fork for an industrial truck such as a forklift truck. The load pick-up means has a portion which can come in contact with the load in order to pick it up, and a portion by means of which the load pick-up means can be fastened to a lifting and lowering device, for example of a forklift truck. A conventional fork has, as the portion that can come in contact with the load for picking it up, a portion that is essentially horizontally aligned during operation. The other portion, with which the fork tine is attachable to a lifting and lowering device of a forklift truck, is substantially perpendicular to the horizontal area, i.e. is substantially vertically oriented in operation.

An “image recording optic” is a means for imaging moving or static images. The image may subsequently be directed onto an exposable film or an optoelectric sensor. An optoelectric sensor has a light-receiving surface with individual areas (pixels) so that—in conjunction with a lens and camera electronics—an electrical image can be generated. The lens is part of the image recording optics. Thus, the image recording optics can be positioned in a camera head, where the optoelectric sensor, also called camera chip, can be located directly behind the image recording optics or at a distance from the camera head and connected to the optics via an optical fiber. A digital camera has an image recording optics, an optoelectric sensor and an electronic system, where all components can be integrated in a housing or the image recording optics can be arranged separately from the other components, for instance connected to them via a light guide.

The image recording optics can record any number of images. Thus, the image recording optics can record not only static images, but also moving images in real time.

The image or video signal can be transmitted via a cable along the first and second portions of the first load pick-up device, for example to a lifting carriage, and from there to a monitor in the driver's cab of an industrial truck. For this purpose, a groove can be provided in the sides of the first and second portions of the first load pick-up device, in which the cable can be laid in a protected manner. The groove can be closed after insertion of the cable so that the outer contour of the first load pick-up device remains unchanged. The groove preferably runs in the neutral line of the first load pick-up device so that there is hardly any weakening, especially in the fork bend area.

Behind the image recording optics, a transmitter and a power supply, for example in the form of a battery, can also be integrated into the first load pick-up device so that the signal can be transmitted wirelessly to the monitor or a receiver outside the industrial truck. For wireless transmission, all common methods can be used, such as radio, NFC, Bluetooth, or the like.

A standard fork tine is at least 40 mm thick, i.e., its extension in the thickness direction y is at least 40 mm, although the extension in the thickness direction y may be smaller in special cases. A common camera is about 25 mm high. The camera can thus be protected from impact forces at the top and bottom by a web on the first portion of the first load pick-up means. The first load pick-up means can thus accommodate an image recording optics that builds at most as high as a camera, as well as a complete camera, in a protected manner. The image recording optics or camera is protected by the first load pick-up means on all sides against impact forces, for example when starting, setting down, lifting etc. loads. The first load pick-up means does not have to have a greater extension in the width direction z than a standard fork tine. Due to the taper of the first portion of the first load pick-up means in the width direction z, the camera lens protrudes more out of the load pick-up means and the forward viewing angle is much more favorable. For example, the viewing window for viewing a pallet lifted by the first load pick-up means becomes about 50% wider than with a non-tapered load pick-up means. The recorded image is far less occupied by the first load pick-up means, such that the image provides significantly more usable information to an operator of an industrial truck. Further, the first load pick-up means is not weakened in the fork bend region between the first and second portions, so that the nominal load carrying capacity that the load pick-up means has without the integrated image recording optics is maintained. Any known image recording optics and any known camera design may be used.

The image recording optics may also be directly received in a recess in the region of the taper of the first load pick-up member. In the region of the taper, the first load pick-up element can also be made of solid material and have only a small recess, for example, only for a lens or the image recording optics.

The taper of the first portion of the first load pick-up means can be arranged at any suitable position in the longitudinal direction x. The further forward, i.e. in the opposite direction to the second portion of the first load pick-up element, it is arranged, the larger the angle of view of the image-recording optics becomes. On the other hand, if it is arranged too far forward, for example, a second load pick-up element may be out of the image area, so that this second load pick-up element can no longer serve as a reference in the captured image. In addition, the probability of impact of the ramp when picking up or setting down a load becomes greater the further forward the ramp is arranged. In practice, an arrangement approximately between one third and two thirds of the horizontal longitudinal extension x of the first portion of the first load pick-up element, measured from the transition from the first to the second portion of the first load pick-up means, for example also approximately in the middle of the longitudinal extension x of the first portion of the first load pick-up means, has proven to be advantageous.

In an advantageous embodiment, the image recording optics is integrated in the ramp in such a way that the ramp protrudes beyond it on both sides in the thickness direction y. This provides optimum protection for the image recording optics in the vertical direction.

In another advantageous embodiment, the image recording optics is integrated in the ramp in such a way that the ramp protrudes beyond it in the longitudinal direction x. In this way, the image acquisition optics are optimally protected in the vertical direction. This provides optimum protection for the image recording optics in the horizontal direction.

In a further advantageous embodiment, the ramp is continued in the opposite direction to the second portion of the first load pick-up means beyond the region of the image recording optics. This further tapering of the first load pick-up means further optimizes the angle of view of the image recording optics.

In one embodiment, the image recording optics has a longitudinal axis that is substantially parallel to the longitudinal direction of the first portion of the first load pick-up means. Consequently, the imaging angle corresponds to that of an operator or driver of an industrial truck who is positioned behind a picked-up load.

In an alternative embodiment, the image recording optics has a longitudinal axis that extends at an angle α not equal to 0° to the longitudinal direction of the first portion of the first load pick-up means. For example, the angle α can be adjusted such that the longitudinal axis of the image recording optics extends away from the longitudinal axis of the first portion of the first load pick-up means as viewed in the direction of the taper of the first portion of the first load pick-up means. This further increases the angle of view of the image pick-up optics. This also improves the view of a second load pick-up means, if present and arranged substantially parallel to the first load pick-up means.

The field of view to the front is further improved in that the width extension y of the first portion of the first load pick-up means in the region behind the ramp, as seen from the second portion of the first load pick-up means, is designed to be slightly beveled towards the tip of the first load pick-up means. This bevel can have, for example, 2°, measured between the center axis of the first portion of the first load pick-up means and the contour of the first load pick-up means at this location.

In one embodiment, the image recording optics is arranged directly in front of an optoelectric sensor. This achieves a compact design of the camera.

In an alternative embodiment, the image recording optics is operatively connected to an optoelectric sensor via an optical fiber. The optoelectric sensor can thus be arranged at a different location, for example behind the second portion of the first load pick-up means, which minimizes the space required at the first portion of the first load pick-up means.

In a further advantageous embodiment, the image recording optics additionally comprises an illumination device. Thus, an optimally exposed image can be obtained, even if the image to be captured is in darkness. The illumination device may, for example, comprise an LED, another illuminant, or even a laser. The illumination device may also comprise a light guide, whereby the illuminant or laser may be located at a different position on the first load pick-up means, while the light is guided to the image recording optics via the light guide so that it illuminates the area of interest for the image.

In a further advantageous embodiment, the image recording optics additionally comprises a distance measuring device. Thus, in addition to the image, a distance from, for example, a shelf on which a load is to be placed or a corresponding stop can be transmitted as a measurement, for example, to an operator of an industrial truck to which the first load pick-up means is attached.

An inventive system for picking up and setting down loads with a first load pick-up means described above is characterized in that the system additionally comprises a second load pick-up means arranged substantially parallel to the first load pick-up means.

The second load pick-up means may correspond to the first load pick-up means, i.e. it may also include an image recording optics. However, the second load pick-up means can also be a standard fork, for example, i.e. in particular have no image recording optics. An image recording optics can be provided either on one or on both side surfaces of the first and/or the second load pick-up means. If an image recording optics is arranged on an outer side of a load pick-up means, it can be directed outward. In this case, the outer side of a load pick-up means is the side facing away from the other load pick-up means. Image recording optics can also be provided on both load pick-up means, where both image recording optics can be mounted on the respective inner sides of the load pick-up means. The inner sides of the load pick-up means are the sides facing the other respective load pick-up means. If, for example, the load pick-up means are moved far apart in a tine adjustment, this constellation is advantageous if the position of each load pick-up means and the insertion of each load pick-up means into a pallet must be monitored. If the system contains only one image recording optic, it is less expensive than if it contains two image recording optics. On the other hand, two image recording optics provide two images, which give a better impression of the situation due to the distance between the two image recording optics, especially if the two load pick-up means are far apart. In an advantageous embodiment, the first load pick-up means and the second load pick-up means are arranged such that the image recording optics faces in the direction of the other load pick-up means. In other words, in this embodiment the image recording optics of the first load pick-up means is arranged on the side of the first load pick-up means facing the second load pick-up means. If two image recording optics are installed, both image recording optics can face each other. However, it is also possible to arrange one or both image recording optics on the outer sides of the load pick-up means, i.e., to arrange them on the side(s) of the load pick-up means facing away from the other load pick-up means.

The second load pick-up means can be used as a reference depending on the distance from the back of the fork.

In an advantageous embodiment, the system additionally comprises an optoelectric sensor. Furthermore, the system may additionally comprise a monitor for displaying the image captured by the image recording optics. If this monitor is arranged in the field of view of an operator or driver of an industrial truck, this operator can safely maneuver the industrial truck even in the case of a direct view of the travel path restricted by a load picked up by the load pick-up means of the industrial truck and, in particular, he can determine the exact position of the load in relation to the position of the load pick-up means better than before when setting down or picking up a load.

Further advantages, special features and expedient further developments of the invention are apparent from the dependent Claims and the following illustration of preferred embodiments based on the figures.

### IN THE FIGURES

FIG. 1 shows a first load pick-up means according to the invention in a three-dimensional view;

FIG. 2 shows a further embodiment of a first load pick-up means according to the invention in a three-dimensional view;

FIG. 3 shows a system according to the invention with a first and a second load pick-up means in a top view;

FIG. 4 shows a system according to the invention with a first and a second load pick-up means and a pallet picked up in a plan view;

FIG. 5 shows a first load pick-up means according to the invention in a front view;

FIG. 6 shows a system according to the invention with a first and a second load pick-up means and a picked-up pallet in a front view.

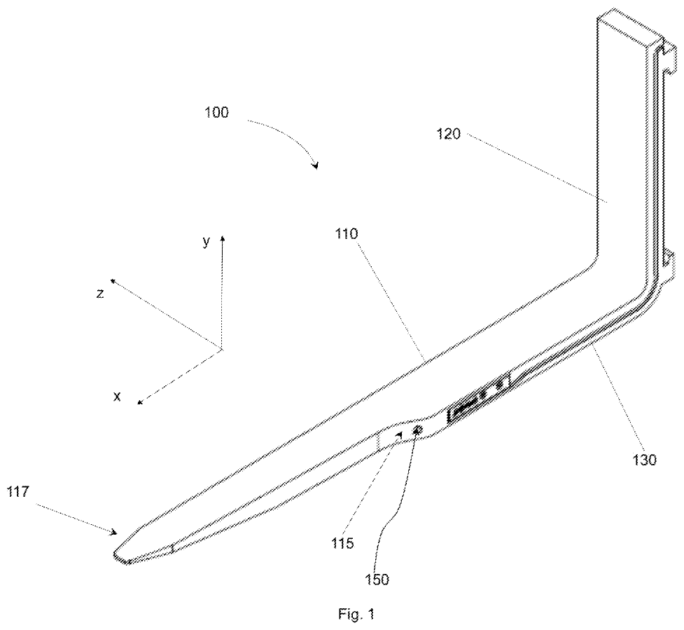

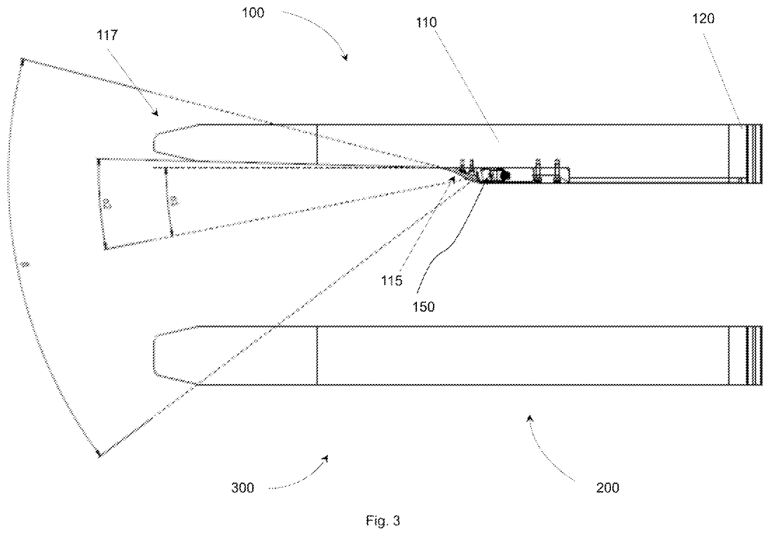

FIG. 1 shows a first load pick-up means 100 according to the invention in a three-dimensional view. The first load pick-up means 100 has a first portion 110 which is substantially horizontally oriented in operation and has an extension in the horizontal longitudinal direction x, an extension in the vertical thickness direction y, and an extension in the width direction z. Further, the first load pick-up means 100 comprises a second portion 120 substantially perpendicular to the first portion 110. Further, the first load pick-up means 100 comprises integrated image recording optics 150. The width direction z of the first portion 110 of the first load pick-up means 100 tapers in a direction opposite to the second portion 120 of the first load pick-up means 100 via a ramp 115, wherein the image recording optics 150 are integrated in the ramp such that an image can be captured in the direction opposite to the second portion 120 of the first load pick-up means 110. The image recording optics is suitable for capturing moving or static images. The image recording optics 150 is located in a camera head, with a camera chip located remotely from the camera head. The camera chip is connected to the image recording optics 150 via an optical fiber, the optical fiber being guided in a channel 130 that is milled into the side surface of the first pick-up means 110. A standard fork tine has an extension in the thickness direction y of 40 mm, with a usual camera being only about 25 mm high. The camera head is thus protected from impact forces at the top and at the bottom by a web 116 in the first portion 110 of the first load pick-up means 100. The first load pick-up means 100 can thus accommodate an image recording optics 150, which builds at most as high as a camera, as well as a complete camera in a protected manner. The image recording optics 150 or camera is protected by the first load pick-up means 100 on all sides against impact forces, for example during starting, setting down, lifting etc. of loads. The first load pick-up means 100 has no greater extension in the width direction z than a standard fork tine. Due to the taper of the first portion 110 of the first load pick-up means 100 in the width direction z, the camera lens protrudes more from the first load pick-up means 100 and the forward viewing angle, i.e. in the positive x-direction, is much more advantageous. The width dimension y of the first portion 110 of the first load pick-up means 100 in the region behind the ramp 115, as seen from the second portion 120 of the first load pick-up means 100, is designed to be slightly beveled towards the tip 117 of the first load pick-up means 100. This bevel may be, for example, 2°, measured between the central axis of the first portion 110 of the first load pick-up means 100 and the contour of the first load pick-up means 110 at this point (see also FIG. 3). The viewing window for viewing from a pallet picked-up by the first load pick-up member 100 becomes, for example, about 50% wider than a non-tapered load pick-up member. The captured image is far less occupied by the first load pick-up means 100, such that the image provides significantly more usable information to an operator of an industrial truck. Further, the first load pick-up means 100 is not weakened in the fork bend region between the first 110 and the second 120 portion, so that the nominal load carrying capacity exhibited by the load pick-up means without the integrated image recording optics 150 is maintained. Any known image recording optics 150 and any known camera design can be used.

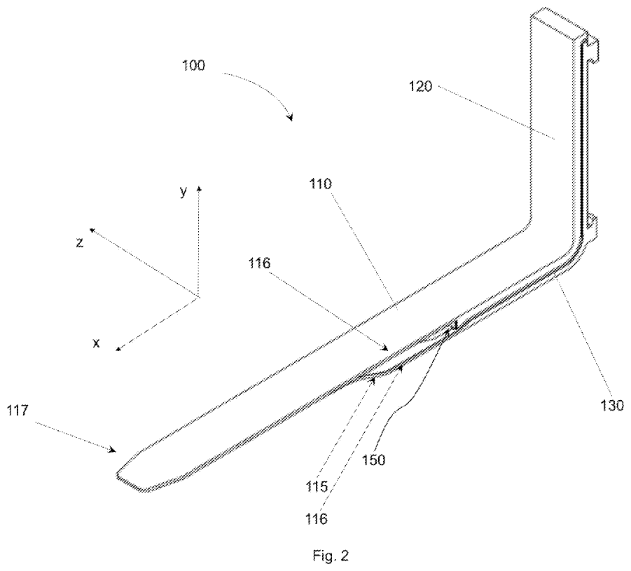

FIG. 2 shows a further embodiment of a first load pick-up device 100 according to the invention in a three-dimensional view. The image recording optics 150 is integrated in the ramp 115 in such a way that webs 116 formed by the ramp 115 protrude beyond it on both sides in the thickness direction y. As a result, the image recording optics 150 is optimally protected in the vertical direction, i.e. in the thickness direction y. Furthermore, the image recording optics 150 is integrated in the ramp 115 in such a way that webs 116 formed by the ramp 115 protrude beyond it in the longitudinal direction x. One or both of the webs 116 can extend to the tip 117 of the first portion 110 of the first load pick-up means 100. In this way, the image recording optics 150 is also optimally protected in the horizontal direction, i.e. in the direction of the x axis.

FIG. 3 shows a system 300 according to the invention with a first 100 and a second 200 load pick-up means in a top view from below, i.e. from the opposite direction to the vertical orientation of the second portion 120 of the first load pick-up means 100. In addition to the first load pick-up means 100, the system 300 comprises a second load pick-up means 200 arranged substantially parallel to the first load pick-up means 100, with the image recording optics 150 facing in the direction of the second load pick-up means 120. The second load pick-up means 120 may be used as a reference depending on the distance from the back of the fork. The image recording optics 150 has a viewing angle (3. Because the first portion 110 of the first load pick-up means becomes thinner toward the tip 117, i.e., its extension in the thickness direction y decreases, the viewing angle (3 extends at least partially under the first load pick-up means 110. The second load pick-up means 120 can be designed analogously to the first load pick-up means 110 in this area, so that the viewing angle β can also pass under the second load pick-up means 120. However, a vertical portion of the viewing angle (3 may still be shaded by the first portion 110 of the first load pick-up means 100 or the second load pick-up means 200. The image recording optics 150 has a longitudinal axis that extends at an angle α1 not equal to 0° with respect to the longitudinal direction of the first portion 110 of the first load pick-up means 100. This angle not equal to 0° can be set such that the longitudinal axis of the image recording optics 150 faces away from the longitudinal axis of the first portion 110 of the first load pick-up means 100 as seen in the direction of the taper of the first portion 110 of the first load pick-up means 100. This further increases the angle of view of the image recording optics 150. With respect to the contour of the first portion 110 of the first load pick-up means 100 on the side where the image recording optics 150 is arranged, the angle of the longitudinal axis of the image recording optics 150 is α2, where α2 is greater than α1. The difference of α2 to α1 is the angle at which the width dimension y of the first portion 110 of the first load pick-up means 100 in the region behind the ramp 115, as seen from the second portion 120 of the first load pick-up means 100, is slightly beveled towards the tip 117 of the first load pick-up means 100. This bevel, and thus the difference between α2 and α1, may be 2°, for example. This beveling increases the angle of view of the image recording optics 150 in the area where shading occurs through the first portion 110 of the first load pick-up means 100.

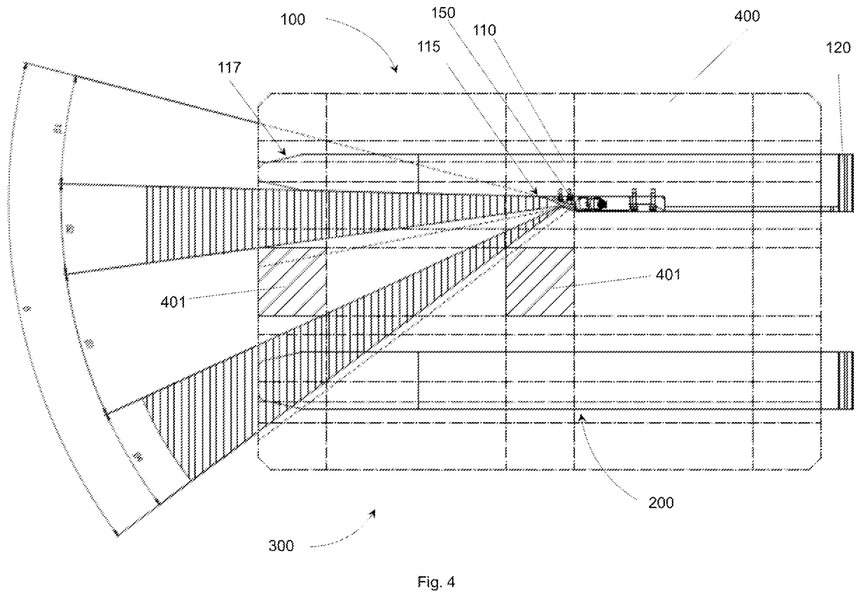

FIG. 4 shows a system 300 according to the invention with a first 100 and a second 200 load pick-up means and a picked-up pallet 400 (shown dashed) in the same view as in FIG. 3. The pallet 400 has reinforcing cubes 401 which lie at least partially in the viewing angle β of the image recording optics 150. Thus, the viewing angle β lying on the plane of these reinforcing cubes 401 is divided and consists of the angles (31, (32 and (34 whereas in each case the angle (33 is cut out of the viewing area 13 by the shadow of a reinforcing cube 401. The viewing area (31 passes under the first load pick-up means 100, while the viewing area (32 also passes within the plane of the load pick-up means 100.

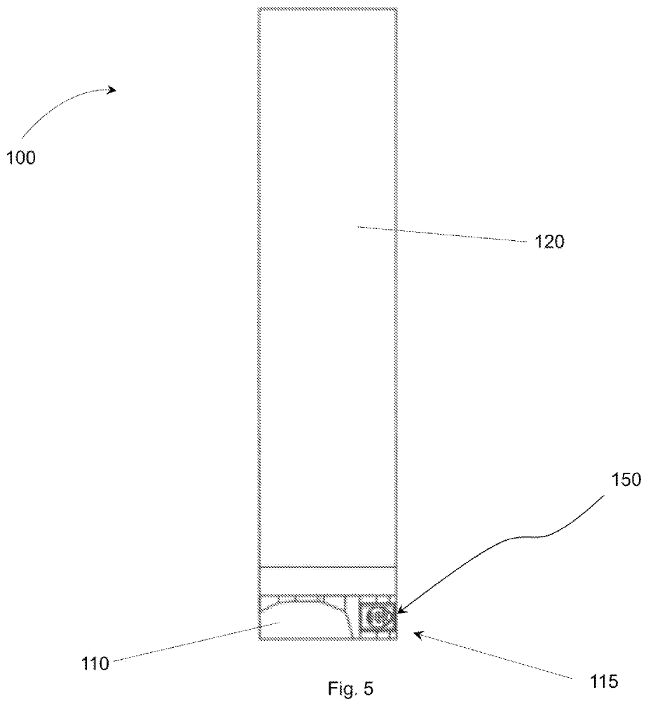

FIG. 5 shows a first load pick-up means 100 according to the invention in a view from the front, i.e. in the negative x-direction. The image recording optics 150 can be clearly seen. The image recording optics 150 are arranged in the ramp 150 with the longitudinal axis of the lens located at a distance from the tapered first portion 110 of the first load pick-up means, which results in a particularly large image capturing angle.

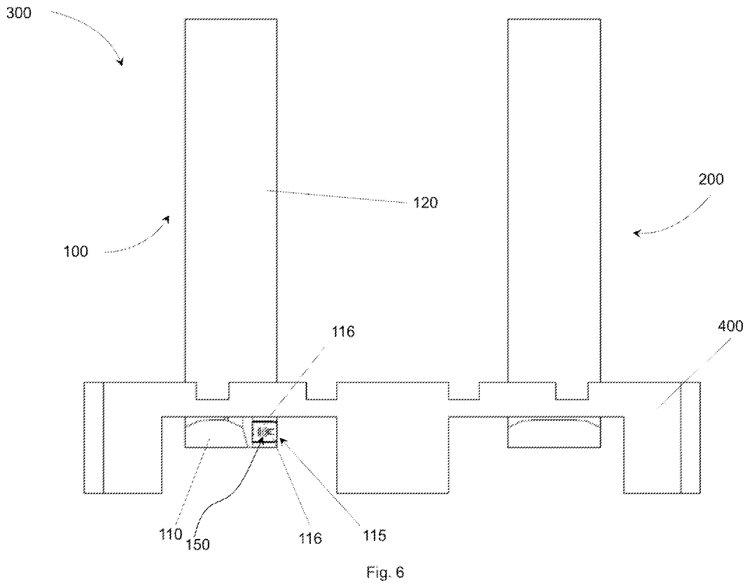

FIG. 6 shows a system 300 according to the invention with a first 100 and a second 200 load pick-up means and a picked-up pallet 400 in a view from the front, i.e. in a negative x-direction. The image recording optics 150 are protected from impact by the pallet 400 on all sides by the webs 116.

The embodiments shown herein are only examples of the present invention and should therefore not be understood as limiting. Alternative embodiments contemplated by those skilled in the art are equally encompassed by the scope of protection of the present invention.

### LIST OF REFERENCE SIGNS

100 first load pick-up means
110 first portion of the first load pick-up means
115 ramp
116 web
117 tip of the first load pick-up means
120 second portion of the first load pick-up means
130 channel
150 image recording optics
200 second load pick-up means
300 system
400 pallet
401 reinforcement cube
x longitudinal direction
y thickness direction
z width direction
α longitudinal axis angle
β viewing angle

1. First load pick-up means having a first portion which is in use oriented substantially horizontally and has an extension in the horizontal longitudinal direction x, an extension in the vertical thickness direction y, and an extension in the width direction z, and a second portion arranged substantially perpendicularly to the first portion, the first load pick-up means having integrated image recording optics,
wherein
the width direction z of the first portion of the first load pick-up means tapers over a ramp in the direction opposite to the second portion of the first load pick-up means, wherein the image recording optics is integrated in the ramp in such a way that an image can be recorded in the direction opposite to the second portion of the first load pick-up means.

2. First load pick-up means according to claim 1,
wherein
the image recording optics is integrated in the ramp in such a way that the ramp protrudes beyond it on both sides in the thickness direction y.

3. First load pick-up means according to claim 1,
wherein
the image recording optics is integrated in the ramp in such a way that the ramp protrudes beyond it in the longitudinal direction x.

4. First load pick-up means according to claim 1,
wherein
the ramp is continued in the direction opposite to the second portion of the first load pick-up means beyond the portion of the image recording optics.

5. First load pick-up means according to claim 1,
wherein
the image recording optics has a longitudinal axis, wherein the longitudinal axis of the image recording optics is substantially parallel to the longitudinal direction of the first portion of the first load pick-up means.

6. First load pick-up means according to claim 1,
wherein
the image recording optics has a longitudinal axis, the longitudinal axis of the image recording optics extending at an angle α not equal to 0° to the longitudinal direction of the first portion of the first load pick-up means.

7. First load pick-up means according to claim 1,
wherein
the width extension y of the first portion of the first load pick-up means in the region behind the ramp, seen from the second portion of the first load pick-up means, is designed to be slightly slanted towards the tip of the first load pick-up means.

8. First load pick-up means according to claim 1,
wherein
the image recording optics is arranged directly in front of an optoelectric sensor.

9. First load pick-up means according to claim 1,
wherein
the image recording optics is operatively connected to an optoelectric sensor via a light guide.

10. First load pick-up means according to claim 1,
wherein
the image recording optics additionally comprises an illumination device.

11. First load pick-up means according to claim 1,
wherein
the image recording optics additionally comprises a distance measuring device.

12. System for picking up and setting down loads, comprising a first load pick-up means according to claim 1,
wherein
the system additionally comprises a second load pick-up means arranged substantially in parallel to the first load pick-up means.

13. System according to claim 12,
wherein
the second load pick-up means corresponds to the first load pick-up means according to claim 1.

14. System according to claim 12,
wherein
the second load pick-up means does not have image recording optics.

15. System according to claim 12,
wherein
the first load pick-up means and the second load pick-up means are arranged in such a way that the image recording optics points in the direction of the other load pick-up means.

16. System according to claim 12,
wherein
the system additionally comprises an optoelectric sensor.

17. System according to claim 12,
wherein
the system additionally comprises a monitor for displaying the image captured by the image recording optics.
